(19) United States
(12) Patent Application Publication
(10) Pub. No.: US 2019/0050479 A1
(43) Pub. Date: Feb. 14, 2019

(54) SYSTEM AND METHOD FOR DYNAMIC SYNTHESIS AND TRANSIENT CLUSTERING OF SEMANTIC ATTRIBUTIONS FOR FEEDBACK AND ADJUDICATION

(71) Applicant: THE DUN & BRADSTREET CORPORATION, Short Hills, NJ (US)

(72) Inventors: Anthony J. Scriffignano, West Caldwell, NJ (US); Warwick Ross Matthews, Victoria (AU); Sean Carolan, Walnutport, PA (US); Ilya Meyzin, New Providence, NJ (US)

(21) Appl. No.: 16/059,306

(22) Filed: Aug. 9, 2018

Related U.S. Application Data
(60) Provisional application No. 62/543,547, filed on Aug. 10, 2017.

(51) Int. Cl. G06F 17/30; G06F 17/27; G06K 9/62

(52) U.S. Cl. CPC G06F 17/30705; G06F 17/30997; G06K 9/6218; G06F 17/2785

(57) ABSTRACT

There is provided a transient dynamic semantic clustering engine that transforms disassociated dynamic data into a recursively curated and attributed, use-case specific association that is enhanced for consumption with structures for opining on the strength or other characteristics of usefulness of association attribution, and provenance of the association through a set of recursively evolving operations.

### BACKGROUND OF THE DISCLOSURE

### 1. Field of the Disclosure

The present disclosure relates to semantic clustering, and more particularly, to a technique that provides a flexible, infinitely extensible structure for clustering semantic attribution on the efficacy or characteristics of an association in a recursively curated and dynamic data environment or otherwise.

### 2. Description of the Related Art

The approaches described in this section are approaches that could be pursued, but not necessarily approaches that have been previously conceived or pursued.

The present disclosure addresses several technical problems that are not addressed in prior art. Presently, the dynamic nature of data overwhelms the ability of existing data processing systems and methods of certain types of synthesis because of multiple factors, including data changing faster than existing systems and methods can associate it, varying degrees of veracity, complex or mutually conflicting use-case requirements, and other factors. As a result, existing data processing systems and methods fail to associate and attribute semantic data in an empirical and useful way. Moreover, existing systems and methods fail to perform association and attribution in a recursive manner, thus delivering results that ignore system learning, or become outdated and even irrelevant quickly (or in some use cases, instantaneously).

Prior art in the field of data association and attribution is based on pattern recognition and classification methods. Existing technical systems and methods that are based on these techniques do not allow association of clusters of data in an empirical and reproducible fashion. The downside of this technical problem is that internally and/or temporally inconsistent results may be delivered to an end user. Furthermore, systems cannot easily adjust to changes in data or rules that affect associations based on various use cases.

Current methods of dynamic association fail in terms of explainability and variations in use because they lack a structured feedback mechanism. This drawback is a significant technical deficiency because it does not allow users to continuously improve the performance of association and attribution techniques, nor does it allow for use-case specific flexibility.

Understanding data in modern context is increasingly driven by grouping qualitative and quantitative observations to support decisioning. The concept of semantic clustering is an epistemology that both reduces complexity of such decisions and increases the velocity of decision making. From the technology standpoint, semantic clustering is a technique that identifies relationships within disassociated data based on meaning or other context, and assembles related terms into groupings accordingly. By the virtue of using meaning, semantic clustering is different from other types of clustering modalities, including those that group terms based on similarity or edit distance. For example, a similarity-based clustering technique focused on color, would fail to group terms apple, orange and pear. In contrast, a semantic clustering technique would discover that the terms are related by meaning and may be grouped in a cluster “fruits.”

U.S. Pat. No. 8,438,183 (hereinafter “the US '183 patent”) describes a system and method for ascribing actionable attributes to data that describes a personal identity. In this regard, the US '183 patent describes a more complex approach to semantic clustering, namely a system and method for ascribing actionable attributes to data that describes a personal identity, wherein flexible, alternative indicia are recursively curated to resolve identity of people in the context of business, virtual businesses, or other identity situations where the subject data is highly dynamic and open to different interpretations of veracity.

Feedback structures can be flexible, mirroring the incidence and inception of flexible indicia in inquiry. The nature of such flexible indicia is that they are finite, but unbounded. Accordingly, without evolving the method of providing such feedback, the results can be exhaustive, but not useful to an automated approach to ingestion or other use-cases.

A challenge with the prior art in its existing state is that provided feedback does not have the ability to inform required changes to the rules that were employed in the first place to provide the feedback. That is, the existing method does not provide the ability to change the rules recursively based on the provided feedback.

There is a need for a method to expand on the concept, providing feedback that is immediately dispositive, self-defining, organized, and actionable. There is also a need for a method that can recursively transform provided feedback into decisions on required rule changes and incorporate those changes into the association and attribution techniques.

### SUMMARY OF THE DISCLOSURE

It is an object of the present disclosure to provide a flexible, infinitely extensible structure for clustering semantic attribution on various types of flexible, alternative indicia, including those that are recursively curated to resolve identity of people in the context of business, virtual businesses, or other identity situations where the subject data is highly transient and dynamic and open to different interpretations of veracity.

The present disclosure addresses the above-mentioned technical problems by providing a flexible, infinitely extensible structure for clustering semantic feedback on the efficacy of an association in a way that is consistent with, but significantly more complex than, the practice of opining on the strength of a match, e.g., ConfidenceCode, attribution of the association, e.g., MatchGrade, and provenance of the association, e.g., MatchDataProfile. Other observations might include virtual instantiation, such as web presence or behavior, such as atypical velocity of information change. The first step in providing such feedback is to consume the output of a transient dynamic clustering process in which multiple indicia are adjudicated to form an opinion of personal identity or other objective.

Accordingly, there is provided a method that includes (a) curating disassociated data based on ontology and metadata analysis, thus yielding curated data; (b) transforming the curated data in accordance with transition rules, thus yielding dynamically clustered associated information; (c) attributing the dynamically clustered associated information into data in expandable dimensions, thus yielding attributed data; (d) constructing derived observations from the attributed data; and (e) delivering the attributed data and the derived observations to downstream consuming applications. There is also provided a system that performs the method, and a storage device that includes instructions that control a processor to perform the method.

### BRIEF DESCRIPTION OF THE DRAWINGS

FIG. 1 is an illustration of a process of transient dynamic clustering through flexible alternative indicia

FIG. 2 is an illustration of an exemplary categorization of flexible alternative indicia.

FIG. 3 is a representation of an example of one manifestation of a flexible quality string (FQS) embedded in semantic families.

FIG. 4 is a block diagram of a typical system that performs semantic clustering.

FIG. 5 is a block diagram of operations performed by a transient dynamic semantic clustering engine, showing the recursive nature transforming disassociated data into attributed associated data to be delivered to downstream applications.

FIG. 6 is a block diagram of a system that is an exemplary embodiment of the system of FIG. 4.

A component or a feature that is common to more than one drawing is indicated with the same reference number in each of the drawings.

### DESCRIPTION OF THE DISCLOSURE

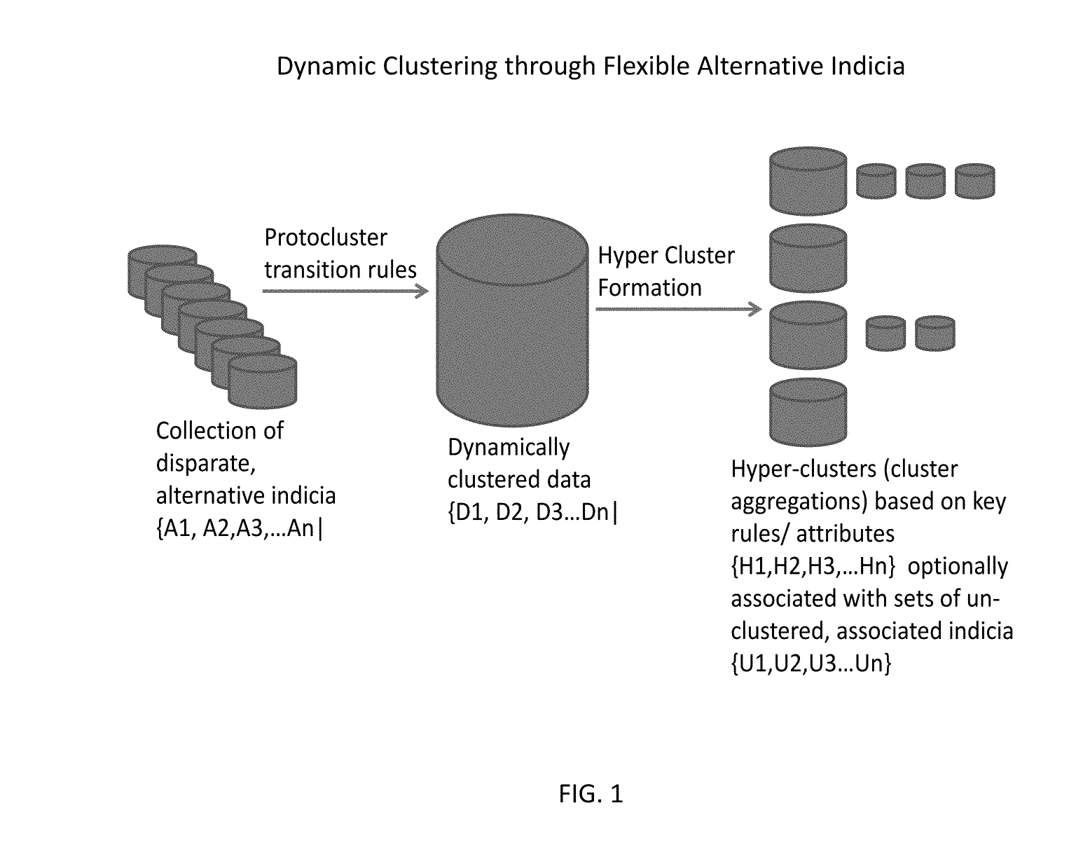

FIG. 1 is an illustration of a process of dynamic clustering through flexible alternative indicia. In this process, data-sets are created that comprise inter alia collections of references to unique identifiers within heterogeneous collections of indicia {A1 . . . An} so that they may be viewed as having been dynamically organized into clusters of data {D1 . . . Dn} via a set of “proto-cluster transition rules”, which include use-case specific association modalities and recursive techniques to curate additional data. Proto-cluster transition is a term used to refer to the transformation of previously unclustered data into dynamic clusters based on a set of use-case-specific rules. Dynamically clustered data can be further re-aggregated into “hyper-clusters” {H1 . . . Hn}, which are formed through association rules or attributes with previously unclustered data, e.g., which did not survive proto-cluster transition. Such hyper-clusters may then be associated with one or more sets of disparate indicia which have not been dynamically clustered due to failure to meet proto-cluster transition requirements.

An example of a data which has been transformed via proto-cluster transition might be a set of rows from disparate data sets which can be combined into a dynamic cluster based on a set of rules. For example, data from a customer contact database, a collection of social media profile information, and a set of vendor information might be connected based on observation of orthographic and phonetic similarity of name, combined with understanding of job function and organization association. The rules for such combination might be use-case specific to a set of rules for understanding organizational balance of trade. Furthermore, a hyper-cluster might be created by grouping all dynamic clusters associated with the same organization (e.g., each dynamic cluster might be about an individual, while the collection of individuals would have a shared association to a common organization). Some original data that did not have enough content to survive proto-cluster transition into a dynamic cluster, for example a row from a customer contact database that was missing a surname for an individual, might still be associated with the hyper-cluster (collection of dynamic clusters) formed by the loose association based on company association.

Hereinafter, to simplify nomenclature in the present disclosure, reference to “clusters” or “clustering” will include hyper-clusters as if the relevant indicia are components of a single cluster or hyper-cluster even though the reality is per the foregoing.

The key challenge to this approach is that a given dynamic clustering modality may not be universally acceptable for all use cases in all temporal contexts (that is points in time, periods of time or other time-based perspectives). Some use-cases or contexts may require clusters that meet a higher quality or confidence threshold, while others may be unacceptable if they are based on certain modalities. The traditional approach to solving such a problem is to provide a set of static structures that can be used for stewardship or decisioning indicating the strength of an association and other metadata about the reasons and provenance of the association. However, since the approach for personal identity or other complex associative use cases can contain a finite, but unbounded set of indicia, there is a need for a feedback approach that is flexible to match the aggregation modality while still containing characteristics that allow ingestion by automated decisioning and stewardship processes.

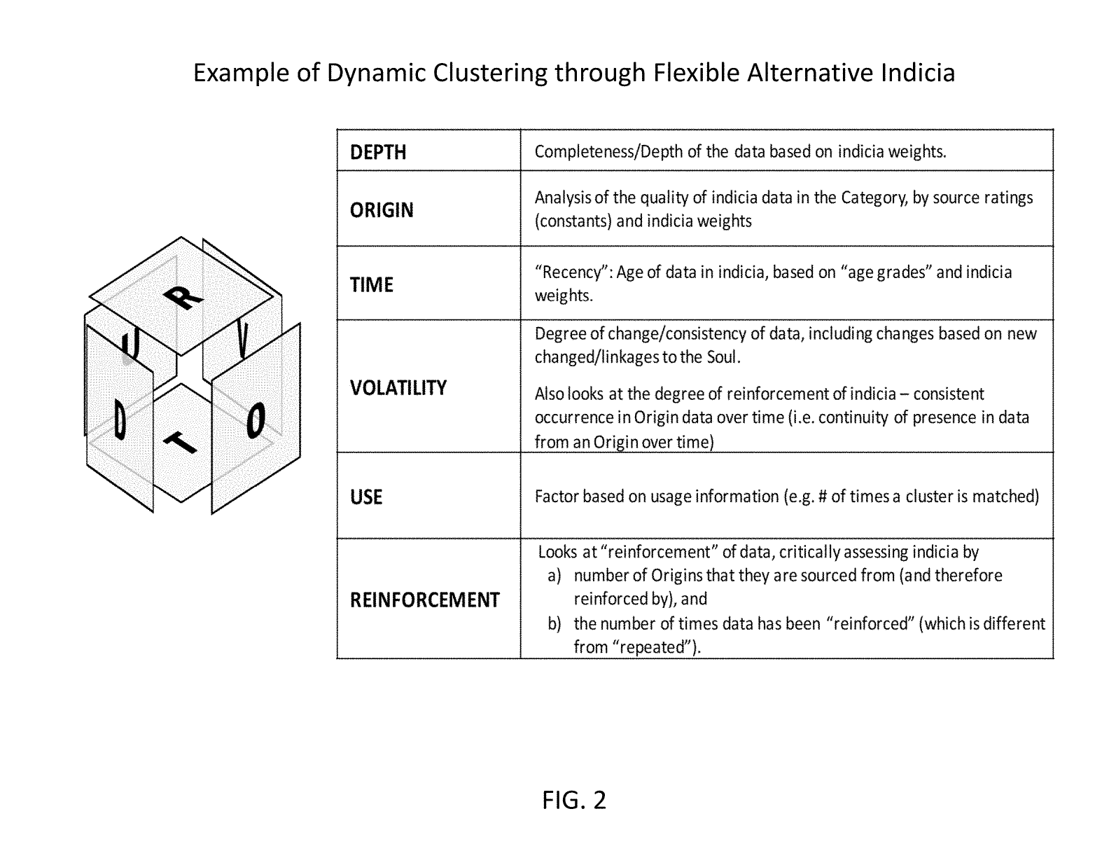

The approach to solving this dichotomy is to apply abstracted or generalized qualitative or quantitative attributions to indicia, or combinations of indicia, in a cluster wherein the various attributes will fall. For example, FIG. 2 depicts one such articulation.

FIG. 2 is an illustration of an exemplary categorization of alternative indicia.

These attributions or “Quality Factors”, and scores (N.B. “scores” here is used in its generic sense that includes indicators, semaphores, ratios, etc.) based upon them, will enable inter alia the definition of “inflection points” (that is, thresholds above or below which certain characteristics may be inferred, or conclusions or dispositions may be made), ranges, grades and other qualitative dimensional measures to the data comprising a cluster and putatively referring to an individual.

In addition, it is necessary to compare and contrast indicia inside and outside the clusters in order to make determinations that enable the assembly, recombination or destruction of clusters, the testing and ongoing maintenance of clusters, and other identity resolution use-cases.

There is an inherent flexibility of the data model via which the indicia are classified, including the ability to add attributes that have not previously been recognized, to which predictive weighting and other information can be defined. This flexibility creates a challenge to the comparison process, in that the regimes of comparisons that measure correlation (similarity) between indicia must themselves also be flexible, in order to avoid the consequence of being limited to “deterministic” correlation, that is, being able to only use those indicia that have been previously “hard-wired” into to a correlation regime. Further, any feedback and resultant decision-making processes must also be updated, and so on, creating a very inefficient and inflexible regime.

Therefore, the present approach also allows for generation of a predetermined set of qualitative attributes (generated by processes such as scorecards or scoring techniques) which can take as inputs a non-predefined set of indicia. The present disclosure only requires either that the indicia metadata includes membership of a basic grouping (that is, it has been pre-classified) or that correlation can itself provide this metadata from the reference side (that is, the classification of an incoming indicium can be derived from and following qualitative assessment of its similarity to a known piece of data from the reference data-set).

These qualitative attributes are “predetermined” in that they are finite, bounded collections of attributes, although the membership of the indicia that are assessed in order to generate them is, in any given case, flexible. For the purposes of this document these collections are called “families”.

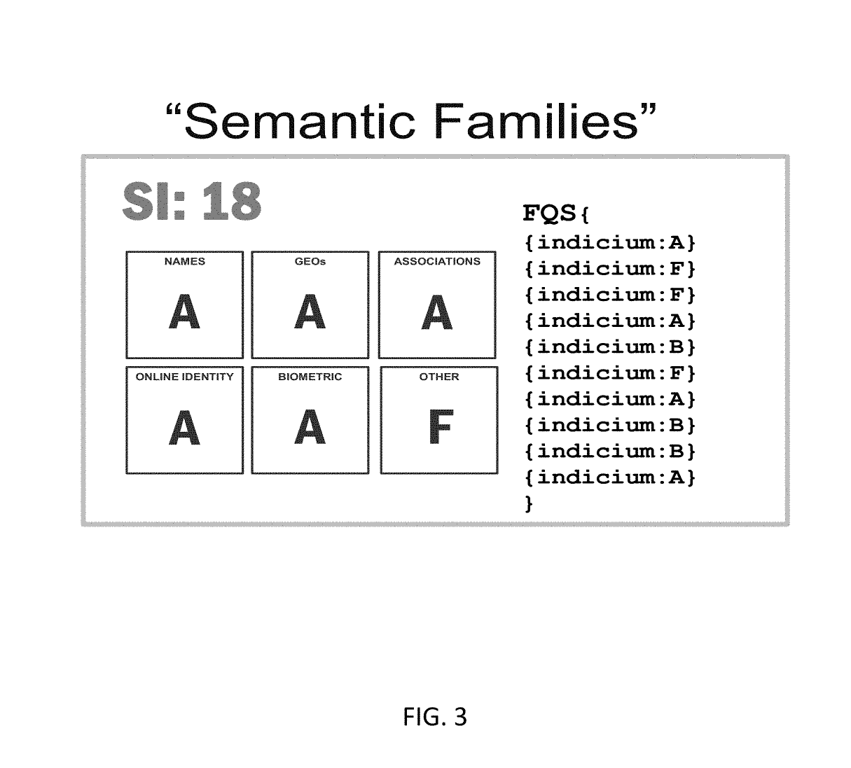

The resultant feedback includes predetermined actionable data (family scores) and contextual self-identifying sentinel values that reflect assessments of the non-predetermined inputs. Such feedback may resemble FIG. 3.

FIG. 3 is a representation of an example of a flexible quality string (FQS) embedded in semantic families.

In this approach, a semantic family contains one or more indicia members, each of which will be attributed according to the results of the correlation exercise (i.e., the process of correlating data based on use-case specific rules, also referred to as proto-cluster and hyper-cluster operations), and any of which if present in the correlation process, i.e., the process of performing such exercises, will contribute to the calculation of the family to which they are associated.

Additional feedback can also be provided on the transition association itself, including origin weights, e.g., feedback on the source of indicia, corroboration, e.g., other indicia that sustain the prior observance of an association, or repudiation.

An end-to-end process for consuming such feedback includes, but is not limited to, the following:
1. ingesting feedback;
2. unpacking the flexible ontology, i.e., deriving the relevant metadata and associating data with that understanding;
3. establishing ingestion of data elements for first-time observation of new indicia;
4. consumption of data output into downstream use-case; and
5. providing feedback to an upstream process on unacceptable associations and/or un-curated indicia.

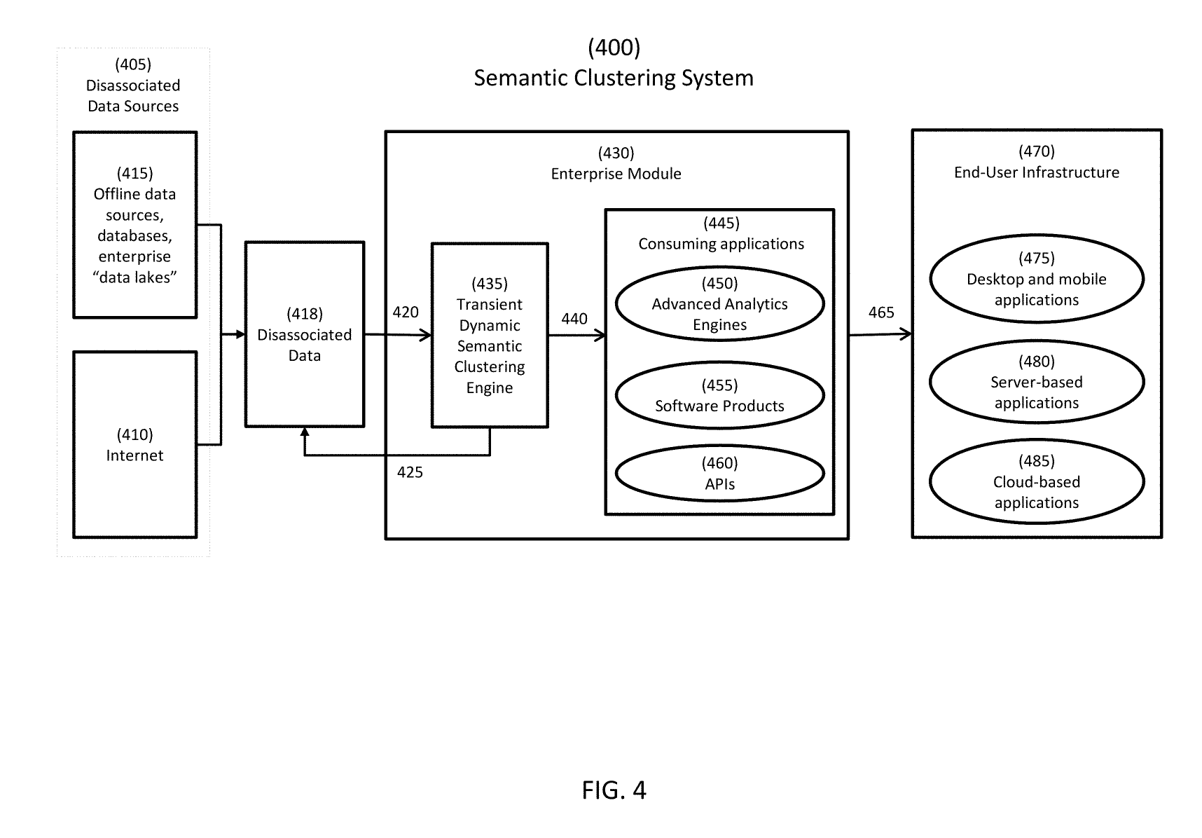

FIG. 4 is a block diagram of a system 400 that performs semantic clustering. System 400 includes (a) disassociated data sources 405, (b) an enterprise module 430, and (c) end-user devices and infrastructure, which are collectively referred to herein as end-user infrastructure 470.

Disassociated data sources 405 are multiple disparate heterogeneous sources of data that may be indicative of identity of people in the context of business, virtual business or other identity situations. Examples of disassociated data sources 405 include (a) the Internet 410, and (b) offline data sources, databases, and enterprise “data lakes”, which are collectively designated as sources 415.

Enterprise module 430 includes (a) a transient dynamic semantic clustering engine, which is referred to herein as engine 435, and (b) consuming applications 445.

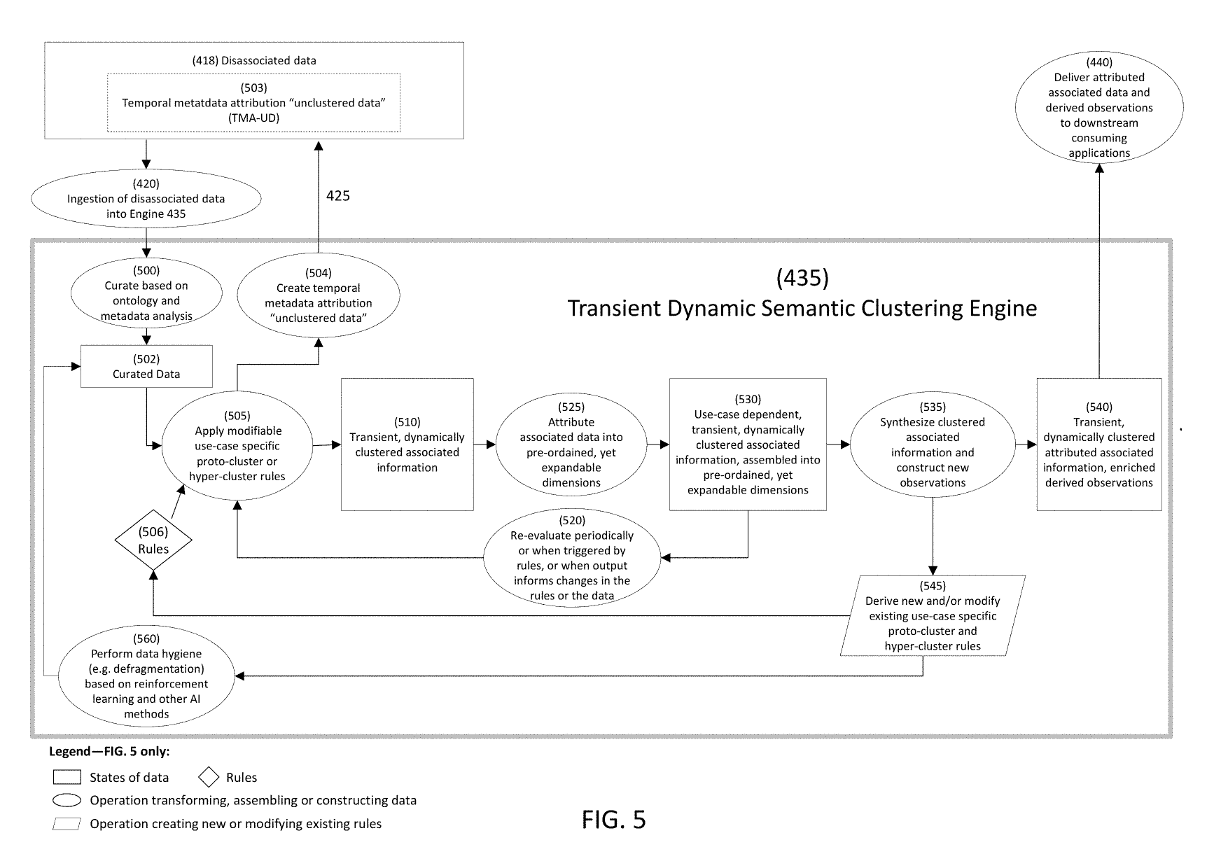

Engine 435 (a) ingests disassociated data 418 from disassociated data sources 405 in operation 420, (b) fabricates and delivers attributed associated data 540 (see FIG. 5) to consuming applications 445 in operation 440, and (c) via a feedback loop 425, searches for and ingests new disassociated data from existing sources or new sources in disassociated data sources 405.

Consuming applications 445 receive attributed associated data 540 (see FIG. 5), and produce, transport and deliver data 465 for end-user infrastructure 470. Consuming applications 445 include analytics engines 450, software products 455, and application program interfaces (APIs) 460.

End-user infrastructure 470 receives data 465 and utilizes it in accordance with its needs. End-user infrastructure 470 includes desktop and mobile applications 475, server-based applications 480, and cloud-based applications 485.

FIG. 5 is a block diagram of operations performed by engine 435.

In operation 500, disassociated data 418 is curated based on ontology and metadata analysis, where “disassociated data” means raw data from multiple online and/or offline sources, e.g., a company's customer relationship management (CRM) database, social media posts, and industry membership affiliations publications. Operation 500 yields curated data 502.

In operation 505, curated data 502 is transformed into transient, dynamically clustered associated information, i.e., data 510. This transformation is accomplished via a collection of modifiable use-case specific proto-cluster or hyper-cluster transition rules, i.e., rules 506. For example, one use case may require a high degree of exact similarity among combined elements, while another may allow for interpretation based on proximity of geolocation, phonetic similarity, behavioral attributes, or other less dispositive observation. Modifiable use-case specific rules 506 identify relationships between seemingly disparate data elements and assemble those elements into clusters of associated information (e.g., John Smith, employed by ABC Inc., according to a CRM database in sources 415 may associate with social media posts from sources 415 about ABC's new products, and an XYZ elementary school board member based on a set of association rules 506 that consider name, social media handles, location, and seniority of position).

Operation 505 also triggers operation 504, which creates a temporal metadata attribution “unclustered data”, i.e., TMA-UD 503, in disassociated data 418. TMA-UD 503 is created because not all data will immediately meet cluster association requirements: a data element may not be associated with a cluster if no applicable rules 506 or other modalities, i.e., association or transformation of data, exist for a specific data type or existing rules and modalities cannot draw an association inference. For instance, curated data 502 contains information about a John Smith who graduated from Acme University. If the existing combination of curated data 502 and rules 506 does not allow attribution of this university affiliation to any of the existing “John Smith,” this particular data element will be temporarily tagged as “unclustered data” in operation 504.

Attribution, however, may become possible in the future with changes to disassociated data 418 or rules 506. Accordingly, operations 420 and 500 will subsequently be re-executed on the tagged data, i.e., the data that was temporarily tagged as “unclustered data”, in conjunction with other data elements in disassociated data 418. In the example above, new disassociated data 418 or new rules 506 may make attribution of “John Smith, an Acme University graduate” possible. In that situation, operation 504 would not establish the attribute “unclustered data”, because the data will be clustered with some other data on successive iterations to establish TMA-UD 503 in disassociated data 418.

Critically, the process of associating new data elements with a specific cluster is dynamic and recursive. New associations are constructed, for instance, when new potentially relevant information in disassociated data 418 is detected or when association rules 506 are refined or added. Recognition of potentially relevant data can be accomplished through various methods, including partial key matching, phonetic similarity, artificial intelligence (AI) classification methods, anomaly detection, or other approaches, depending on use case. Thus, in operation 505, the process of data attribution and clustering will be continuously and recursively modified based on the results of operations 520 and 545 (discussed below), where existing proto-cluster and hyper-cluster rules 506 may be modified, and new proto-cluster and hyper-cluster rules 506 may be generated. This intrinsic “recursiveness” of engine 435 will ensure that the following data will be re-evaluated periodically or when triggered by a relevant rule: disassociated data 418, curated data 502, data 510, and finally, the use-case dependent, transient, dynamically clustered associated information, i.e., attributed associated data 540, assembled into pre-ordained, yet expandable dimensions. Insights from this recursive evaluation process implemented in engine 435 will be delivered in the form of attributed associated data 540 as an input to operation 440.

In operation 525, data 510 is fabricated into pre-ordained, yet expandable dimensions, i.e., data 530, that can vary depending on a specific use-case. FIG. 2 shows an example of such pre-ordained dimensions. In this example, the dimensions include Depth and Volatility. Within those dimensions there exists a capability to have an expanding amount of granular feedback curated through an extensible ontology. FIG. 3 shows an example of such an extensible ontology wherein the dimensions (referred to in FIG. 3 also as semantic families) have a finite, but unbounded collection of indicia associated with specific sub-aggregation within the overall concept associated with that dimension. Values for each of these indicia can be computed, derived or assigned using various methods. For instance, if the use-case is resolving identity of an individual in the context of business, pre-ordained dimensions may include basic information (name, previous names, age, gender, etc.), contact information (address, work address, phone numbers, email addresses, social media handle, social media account, etc.), professional history (employment, professional awards, publications, etc.), personal affiliations (college alumni clubs, sports organizations, etc.) and so forth. Both the number of dimensions and the number of data elements assigned to specific dimensions can be expanded as new information is associated with a specific data cluster.

In operation 535, dynamically clustered information that has been assembled into pre-ordained dimensions, i.e., data 530, is synthesized and constructed into new higher-level insights and observations, i.e., attributed associated data 540. This synthesis can be accomplished through classification, modeling, heuristic attribution, reinforcement learning, convolution recognition, or other methods. For instance, if John Smith's cluster contains information on membership in a golf club, numerous social medial posts on retail point-of-sale technology innovation by DEF company, and an address in a zip code with high household income, it is possible to derive that John Smith is a senior executive with DEF company.

In operation 545, new proto-cluster and hyper-cluster rules 506 are created. This creation can be triggered by observation of curated data 502 that fails to discriminate with existing rules 506, i.e., rule refinement, through observation of externalities (such as changes in the environment from which data is curated resulting in missing information or information with questionable veracity), through triggers (such as changes in the quality and character of information) or external intervention (such as changes in the regulatory environment related to permissible use of information). These new proto-cluster and hyper-cluster rules 506 are then embedded into operation 505, where curated data 502 is transformed into data 510, and in association with operation 504, TMA-UD 503 is created. Operation 545 is employed continuously and recursively. Operation 545 is critically important to the successful association and attribution of transient and dynamic data: the recursive nature of the method represented by operation 545 allows engine 435 to address the nature of unstructured data sources such as the social media.

In operation 560, data hygiene is performed on curated data 502. For instance, fragmented and “orphaned” data, i.e., data that previously was not clustered or attributed in operation 505, for example because no association rules or methods were able to be applied, is reevaluated in an attempt attribute unclustered data in light of new observations in operation 535 and/or new rules created or modified in operation 545. Reinforcement learning and other AI methods can be employed for the purpose of such data defragmentation.

In operation 440, dynamically clustered information, i.e., attributed associated data 540, with derived insights where applicable, is delivered to downstream applications, i.e., consuming applications 445. For instance, in the case of resolving identity of an individual in the context of business, consuming downstream applications 445 could be CRM software, loan approval software, and so forth. A CRM application may utilize outputs from engine 435 to construct highly targeted marketing campaigns, or loan approval software may incorporate derived higher-level insights to augment traditional loan evaluation mechanisms.

An example employing the technique disclosed herein might involve adjudication of malfeasant behavior. Consider disassociated data 418 that includes a CRM database (current customers and information on interaction with those customers), a separate set of user comments and inquiries, a separate set of accounts payable information, and a queue of pending orders, and that is ingested by operation 420 and curated by operation 500, thus yielding curated data 502.

This particular case might involve vetting of the pending orders to confirm that the ordering party is who they claim to be and that they are authorized to create indebtedness to their organization by virtue of the provisioning of goods or services. The disassociated data (disassociated data 418) from each of these separate data sets might result in a set of clustered data about each of the companies who are customers via curation in operation 500 and proto-clustering in operation 505 to produce transient dynamically associated information (data 510). Those clusters (data 510 and associated clusters produced through operation 525, yielding data 530) may contain multiple orders, multiple individual contacts, and multiple prior experiences from each of the organizations and may result in the synthesis of new association observations in operation 535 such as the fact that one or more rules 506 need refinement due to an overly aggressive clustering of information, e.g., one organization used another organization's social media handle in their name. This sort of reevaluation could also occur due to externalities, such as a regulatory change, which could trigger reevaluation in operation 520.

Some data (TMA-UD 503, created in operation 504 and observable in disassociated data 418) will not resolve into any created clusters. Those data elements may represent incomplete, latent or inaccurate data but may also represent potential identity theft or other malfeasance. Two separate applications in consuming applications 445 might receive this data in operation 440. One application, which processes orders and maintains CRM accuracy may receive the clustered data only while another application might receive the unclustered data and clustered data for adjudication of malfeasance.

By examining the flexible indicia (e.g., see FIGS. 2 and 3) of the clustered data and performing anomaly detection in one of consuming applications 445 on the unclustered curated data 502, critical clues might be uncovered for fraud or other malfeasance adjudication. This adjudication may result in the creation or curation of new rules 506 or modification of existing rules 506 to inform future process iteration. In operation 560, data hygiene may also become possible or necessary, where new inferences learned during proto-clustering in operation 505 will be reflected in curated data 502. An example of such inference might include the fact that many unclustered, curated data 502 could be resolved through data interventions such as address cleansing or other stewardship.

The outcomes of the technique disclosed herein (i.e., repeatable, dispositive actions on dynamic data against a varying and use-case specific set of rules) would not be possible through human interaction or the application of prior art for a multitude of reasons. For example, prior art relating to clustering does not consider dynamic, flexible indicia in the context of veracity and variable rules. Typically, one or more of these factors must be held constant for the prior art to be applicable. Human intervention would be quickly overwhelmed since humans cannot make such decision at scale or consistently over time, and such limitation would ultimately reduce the efficacy of the process to the point of disutility. The ability to explain why an action was taken by a downstream system and describe the critical attributes relating to the strength of confidence in that decision, capabilities that are increasingly demanded by business enterprises, the public and regulator, are absent in prior art methods.

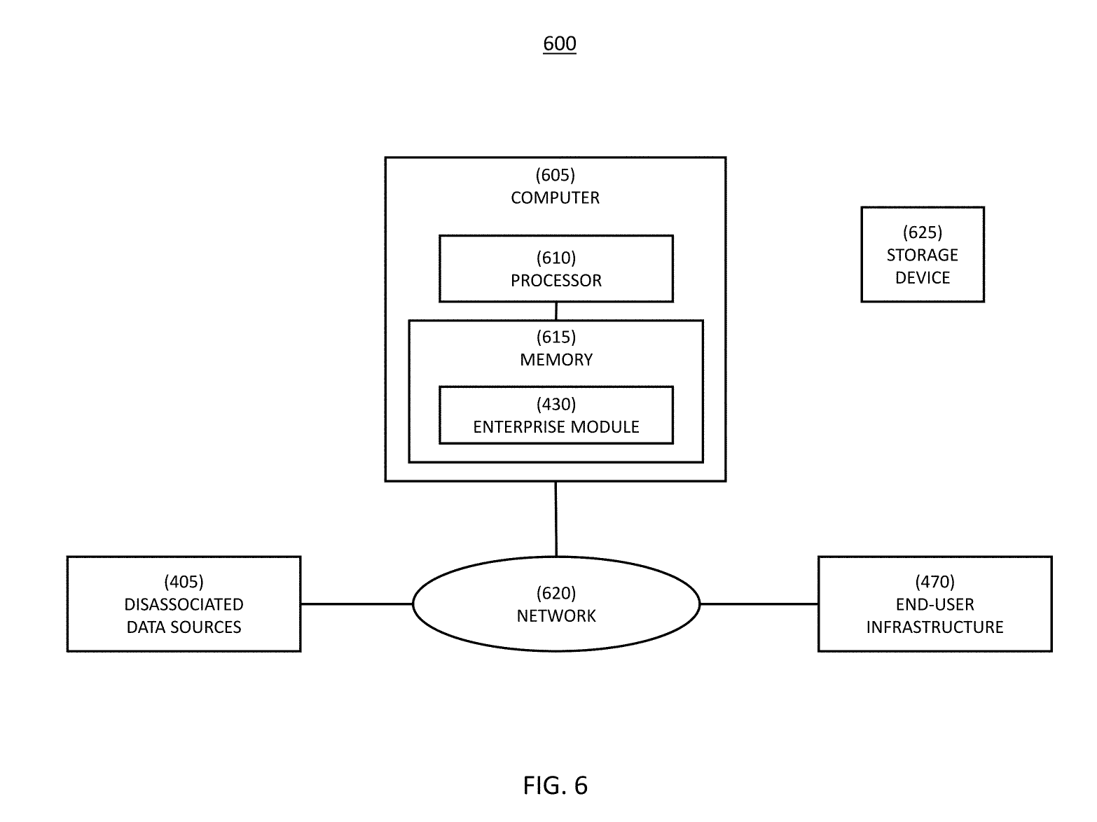

FIG. 6 is a block diagram of a system 600 that is an exemplary embodiment of system 400, and therefore includes disassociated data sources 405, enterprise module 430, and end-user infrastructure 470. System 600 includes a computer 605 that is communicatively coupled, via a network 620, to disassociated data sources 405 and end-user infrastructure 470.

Network 620 is a data communications network. Network 620 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (f) the Internet 410, or (g) a telephone network. Communications are conducted via network 620 by way of electronic signals and optical signals that propagate through a wire or optical fiber or are transmitted and received wirelessly.

Computer 605 includes a processor 610, and a memory 615 operationally coupled to processor 610. Although computer 605 is represented herein as a standalone device, it is not limited to such, but instead can be coupled to other devices (not shown) in a distributed processing system.

Processor 610 is an electronic device configured of logic circuitry that responds to and executes instructions.

Memory 615 is a tangible, non-transitory, computer-readable storage device encoded with a computer program. In this regard, memory 615 stores data and instructions, i.e., program code, that are readable and executable by processor 610 for controlling the operation of processor 610. Memory 615 may be implemented in a random-access memory (RAM), a hard drive, a read only memory (ROM), or a combination thereof. One of the components of memory 615 is enterprise module 430.

In system 600, enterprise module 430 is a program module that contains instructions for controlling processor 610 to execute the operations of engine 435 and consuming applications 445. The term “module” is used herein to denote a functional operation that may be embodied either as a stand-alone component or as an integrated configuration of a plurality of subordinate components. Thus, enterprise module 430 may be implemented as a single module or as a plurality of modules that operate in cooperation with one another.

Although enterprise module 430 is described herein as being installed in memory 615, and therefore being implemented in software, it could be implemented in any of hardware, e.g., electronic circuitry, firmware, software, or a combination thereof.

While enterprise module 430 is indicated as being already loaded into memory 615, it may be configured on a storage device 625 for subsequent loading into memory 615. Storage device 625 is a tangible, non-transitory, computer-readable storage device that stores enterprise module 430 thereon. Examples of storage device 625 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random access memory, and (i) an electronic storage device coupled to computer 605 via network 620.

The techniques described herein are exemplary and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” and “comprising” are to be interpreted as specifying the presence of the stated features, integers, steps or components, but not precluding the presence of one or more other features, integers, steps or components or groups thereof.

The terms “a” and “an” are indefinite articles, and as such, do not preclude embodiments having pluralities of articles.

What is claimed is:

1. A method comprising:
curating disassociated data based on ontology and metadata analysis, thus yielding curated data;
transforming said curated data in accordance with transition rules, thus yielding dynamically clustered associated information;
attributing said dynamically clustered associated information into data in expandable dimensions, thus yielding attributed data;
constructing derived observations from said attributed data; and
delivering said attributed data and said derived observations to downstream consuming applications.

2. The method of claim 1, further comprising:
recognizing that a data element in said curated data does not meet cluster association requirements, thus yielding unclustered data;
tagging, with a temporal metadata attribution indicative of unclustered data, data in said disassociated data that corresponds to said data element, thus yielding tagged data; and
re-executing said curating on said tagged data in conjunction with other data elements in said disassociated data.

3. The method of claim 1, further comprising:
modifying said transition rules in response to said derived observations, thus yielding a change in said transition rules.

4. The method of claim 3, further comprising:
reevaluating said attributed data in said transforming operation, in response to said change in said transition rules.

5. The method of claim 3, further comprising:
performing a data hygiene operation on said curated data, in response to said change in transition rules; and
re-executing said transforming, said attributing, and said constructing.

6. A system comprising:
a processor; and
a memory that contains instructions that are readable by said processor, to cause said processor to perform operations of:
curating disassociated data based on ontology and metadata analysis, thus yielding curated data;
transforming said curated data in accordance with transition rules, thus yielding dynamically clustered associated information;
attributing said dynamically clustered associated information into data in expandable dimensions, thus yielding attributed data;
constructing derived observations from said attributed data; and
delivering said attributed data and said derived observations to downstream consuming applications.

7. The system of claim 6, wherein said instructions also cause said processor to perform operations of:
recognizing that a data element in said curated data does not meet cluster association requirements, thus yielding unclustered data;
tagging, with a temporal metadata attribution indicative of unclustered data, data in said disassociated data that corresponds to said data element, thus yielding tagged data; and
re-executing said curating on said tagged data in conjunction with other data elements in said disassociated data.

8. The system of claim 6, wherein said instructions also cause said processor to perform an operation of:
modifying said transition rules in response to said derived observations, thus yielding a change in said transition rules.

9. The system of claim 8, wherein said instructions also cause said processor to perform an operation of:
reevaluating said attributed data in said transforming operation, in response to said change in said transition rules.

10. The system of claim 8, wherein said instructions also cause said processor to perform operations of:
performing a data hygiene operation on said curated data, in response to said change in transition rules; and
re-executing said transforming, said attributing, and said constructing.

11. A tangible storage device comprising:
instructions that are readable by a processor, to cause said processor to perform operations of:
curating disassociated data based on ontology and metadata analysis, thus yielding curated data;
transforming said curated data in accordance with transition rules, thus yielding dynamically clustered associated information;
attributing said dynamically clustered associated information into data in expandable dimensions, thus yielding attributed data;
constructing derived observations from said attributed data; and
delivering said attributed data and said derived observations to downstream consuming applications.

12. The tangible storage device of claim 11, wherein said instructions also cause said processor to perform operations of:
recognizing that a data element in said curated data does not meet cluster association requirements, thus yielding unclustered data;
tagging, with a temporal metadata attribution indicative of unclustered data, data in said disassociated data that corresponds to said data element, thus yielding tagged data; and
re-executing said curating on said tagged data in conjunction with other data elements in said disassociated data.

13. The tangible storage device of claim 11, wherein said instructions also cause said processor to perform an operation of:
modifying said transition rules in response to said derived observations, thus yielding a change in said transition rules.

14. The tangible storage device of claim 13, wherein said instructions also cause said processor to perform an operation of:
reevaluating said attributed data in said transforming operation, in response to said change in said transition rules.

15. The tangible storage device of claim 13, wherein said instructions also cause said processor to perform an operation of:
performing a data hygiene operation on said curated data, in response to said change in transition rules; and
re-executing said transforming, said attributing, and said constructing.
